(19) United States
(12) Patent Application Publication
(10) Pub. No.: US 2025/0261582 A1
(43) Pub. Date: Aug. 21, 2025

(54) COMPACT MANURE INCORPORATION SYSTEM

(71) Applicant: Gregory John Fortkamp, Fort Recovery, OH (US)

(72) Inventor: Gregory John Fortkamp, Fort Recovery, OH (US)

(21) Appl. No.: 19/059,645

(22) Filed: Feb. 21, 2025

Related U.S. Application Data
(60) Provisional application No. 63/555,962, filed on Feb. 21, 2024.

(51) Int. Cl. A01C 23/00

(52) U.S. Cl. CPC A01C 23/003; A01C 23/008

(57) ABSTRACT

Manure incorporation systems are disclosed including a wheeled frame connected to a toolbar and supporting a manure distribution system. The toolbar can include a plurality of discs, sweeps, coulters, points, and the like, organized in multiple rows and sections, and the manure distribution system can include a swing pipe, a distributor, a plurality of distribution hoses, a plurality of injectors, and a plurality of manure splash hoods or pans, where such components combine to provide a more compact manure incorporation system configuration for storage and transport. Methods of using manure incorporation systems are disclosed.

### REFERENCE TO RELATED APPLICATIONS

This patent application claims the benefit of U.S. Provisional Patent Application Ser. No. 63/555,962 filed on Feb. 21, 2024, and entitled COMPACT MANURE INCORPORATION SYSTEM, the disclosure of which is hereby incorporated by reference herein in its entirety.

### TECHNICAL FIELD

The present application relates to manure incorporation systems and methods for using the same. More specifically, the present application relates to a compact manure incorporation system.

### BACKGROUND

Ground engagement systems refer to agricultural equipment that can be used for a variety of applications, including tilling soil. These ground engagement systems can also be used to facilitate the application of manure and other liquid nutrients as part of a manure incorporation system. Because of their sizes and constructions, such ground engagement systems are difficult to transport. Such issues can be more pronounced for manure incorporation systems that include additional equipment for distributing manure, such as swing pipes, distributors, and hoses, among other components. Conventional ground engagement systems, and particularly, manure incorporation systems may have portions that can be raised and/or rotated to form a more compact unit for transport, but such capabilities are typically limited by the size and nature of the equipment itself, particularly for configurations including swing pipes, distributors, and hoses, which are typically bulky and centrally positioned components. What is desired is a manure incorporation system that allows for improved mobility and ergonomic use of the same.

### SUMMARY

In accordance with one embodiment, a compact manure incorporation system includes a frame defining a longitudinal axis; a manure distribution system comprising a swing pipe, the swing pipe comprising a first, proximal section and a second, distal section; wherein a proximal end of the proximal section is mounted to the frame and a distal end of the proximal section is pivotably connected to a proximal end of the distal section; and wherein the proximal section and distal section are configured to pivot relative to each other between an extended swing pipe position and a compact swing pipe position.

In accordance with another embodiment, a distributor for a compact manure incorporation system includes an inlet configured for connection with a supply source; and a plurality of hose outlets, wherein each of the plurality of hose outlets is configured for connection with a plurality of distribution hoses; wherein the plurality of hose outlets, at respective connections with the plurality of distribution hoses, are in a similar axial configuration, such that the plurality of hose outlets are parallel or substantially parallel to each other.

In accordance with another embodiment, a cleanout ball catcher for a compact manure incorporation system includes a catcher body defining an interior, an inlet, and an outlet and having a removable cover; and a screen residing within the interior to obstruct a cleanout ball entering through the inlet from exiting through the outlet.

### BRIEF DESCRIPTION OF DRAWINGS

The present disclosure will be more readily understood from a detailed description of some example embodiments taken in conjunction with the following figures:

FIG. 1 depicts a perspective view of a manure incorporation system being pulled by a tractor where a swing pipe is positioned in a straight line, according to one embodiment;

FIG. 2 depicts a top view of the manure incorporation system configuration of FIG. 1;

FIG. 3 depicts a side view of the manure incorporation system configuration of FIG. 1;

FIG. 4 depicts a perspective view of the manure incorporation system of FIG. 1, where a swing pipe is positioned at a 30° angle relative to a longitudinal axis of a frame;

FIG. 5 depicts a top view of the manure incorporation system configuration of FIG. 4;

FIG. 6 depicts a perspective view of the manure incorporation system of FIG. 1, where the swing pipe is positioned at a 45° angle relative to the longitudinal axis of the frame;

FIG. 7 depicts a top view of the manure incorporation system configuration of FIG. 6;

FIG. 8 depicts a side view of the manure incorporation system configuration of FIG. 6;

FIG. 9 depicts a perspective view of the manure incorporation system of FIG. 1, where the swing pipe is positioned at a 90° angle relative to the longitudinal axis of the frame;

FIG. 10 depicts a top view of the manure incorporation system configuration of FIG. 9;

FIG. 11 depicts a perspective view of the manure incorporation system of FIG. 1, where the swing pipe is positioned at a 120° angle relative to the longitudinal axis of the frame;

FIG. 12 depicts a top view of the manure incorporation system configuration of FIG. 11;

FIG. 13 depicts a perspective view of the manure incorporation system of FIG. 1, where a distal portion of the swing pipe is positioned at a 45° angle relative to a proximal portion of the swing pipe and the longitudinal axis of the frame;

FIG. 14 depicts a top view of the manure incorporation system configuration of FIG. 13;

FIG. 15 depicts a perspective view of the manure incorporation system of FIG. 1, where the distal portion of the swing pipe is positioned at a 90° angle relative to the proximal portion of the swing pipe and the longitudinal axis of the frame;

FIG. 16 depicts a top view of the manure incorporation system configuration of FIG. 15;

FIG. 17 depicts a perspective view of the manure incorporation system of FIG. 1, where the distal portion of the swing pipe is positioned at a 120° angle relative to the proximal portion of the swing pipe and the longitudinal axis of the frame;

FIG. 18 depicts a top view of the manure incorporation system configuration of FIG. 17;

FIG. 19 depicts a perspective view of the manure incorporation system of FIG. 1, where the distal portion of the swing pipe is positioned at a nearly 180° angle relative to the proximal portion of the swing pipe and the longitudinal axis of the frame;

FIG. 20 depicts a top view of the manure incorporation system configuration of FIG. 19;

FIG. 21 depicts a photographic image of a distributor according to one embodiment;

FIG. 22 depicts a perspective view of a cleanout ball catcher according to one embodiment;

FIG. 23 depicts a perspective, cutaway view of the cleanout ball catcher of FIG. 22;

FIG. 24 depicts a perspective view of the manure incorporation system configuration of FIG. 19, but with a toolbar rotated to a first vertical position, 90° relative to a horizontal position;

FIG. 25 depicts a perspective view of the manure incorporation system configuration of FIG. 24, but with outer portions of the toolbar rotated forward to a compact position;

FIG. 26 depicts another perspective view of the manure incorporation system configuration of FIG. 24;

FIG. 27 depicts a side view of the manure incorporation system configuration of FIG. 24; and

FIG. 28 depicts a top view of the manure incorporation system configuration of FIG. 24.

### DETAILED DESCRIPTION

For the purpose of the present description and of the appended claims, except where otherwise indicated, all numbers expressing amounts, quantities, percentages, and so forth, are to be understood as being modified in all instances by the term “about.” Also, all ranges include any combination of the maximum and minimum points disclosed and include any intermediate ranges therein, which may or may not be specifically enumerated herein.

The present disclosure, in at least one of the mentioned aspects, can be implemented according to one or more of the present embodiments, optionally combined together.

For the purpose of the present description and of the appended claims, the words “a” or “an” should be read to include one or at least one and the singular also includes the plural unless it is obvious that it is meant otherwise. This is done merely for convenience and to give a general sense of the disclosure.

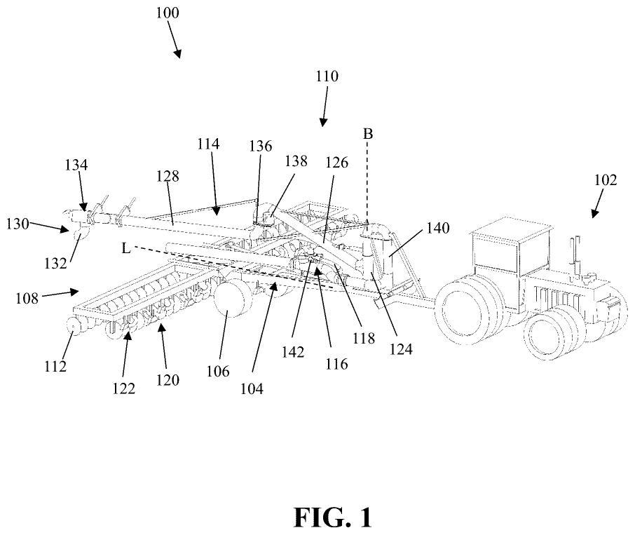

As will be described herein, improved manure incorporation systems are disclosed. Referring to FIG. 1, for example, a manure incorporation system 100 is shown being pulled by a tractor 102. The manure incorporation system 100 can include a frame 104 having wheels 106. It will be appreciated, however, that a manure incorporation system can be pulled by any of a variety of vehicles or be self-powered and a frame can include tracks in addition to or instead of wheels. The frame 104 can be connected to a toolbar 108 and support a manure distribution system 110. The toolbar 108 can be a ground engaging system or a portion thereof. In one embodiment, the toolbar 108 can include a plurality of discs 112, organized in multiple rows and sections. It will be appreciated that, in other embodiments, a toolbar can include a plurality of sweeps, coulters, points, and any of a variety of other suitable components in addition to or instead of discs. Among other components, the manure distribution system 110 can include a swing pipe 114, a distributor 116, a plurality of distribution hoses 118, a plurality of injectors 120, and a plurality of manure splash hoods 122 (or splash pans).

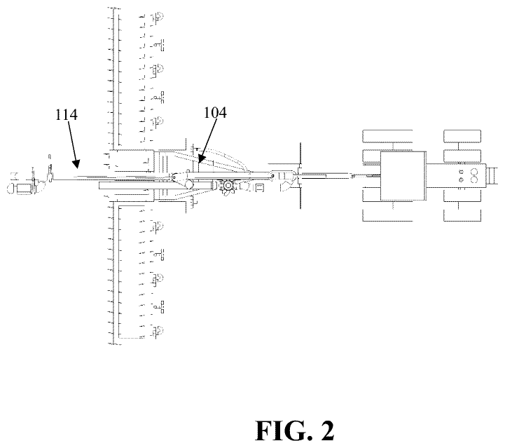

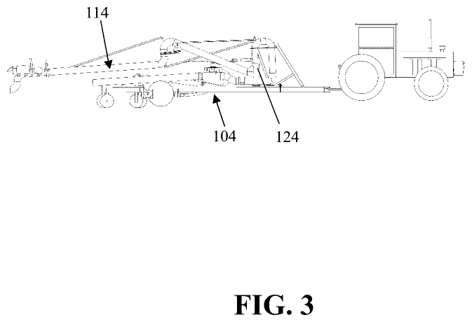

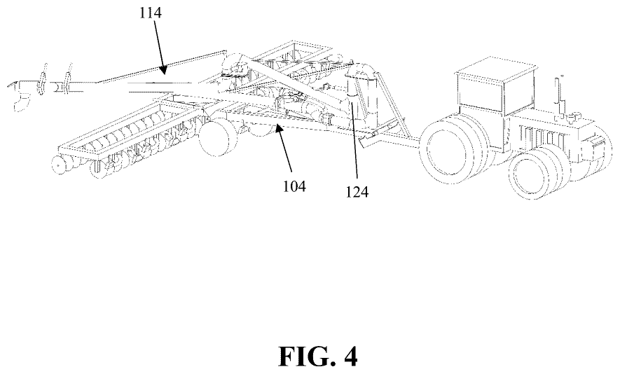

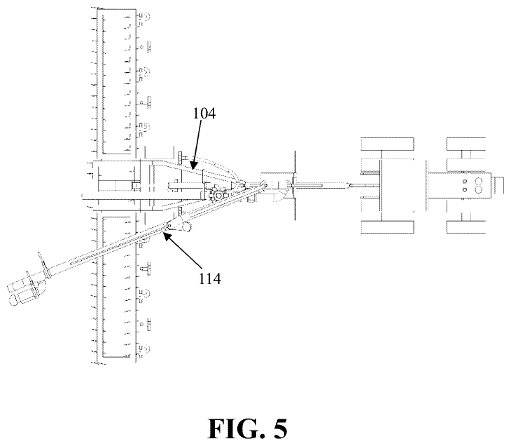

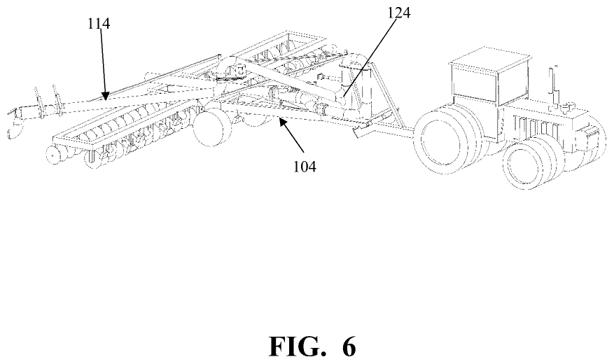

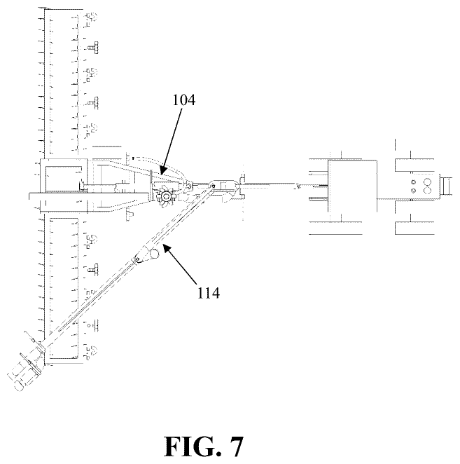

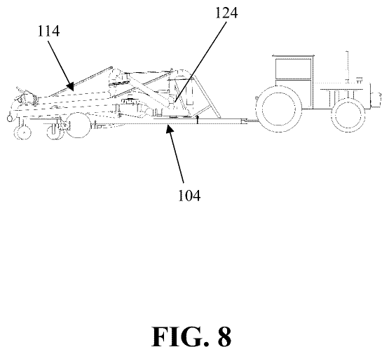

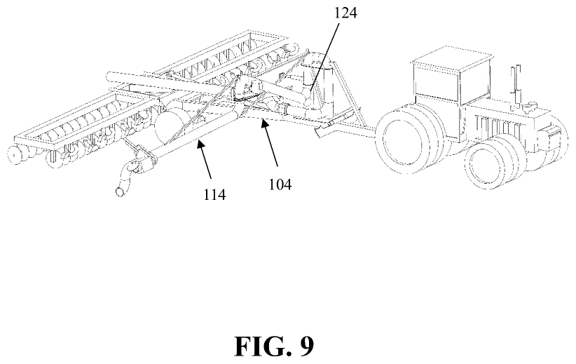

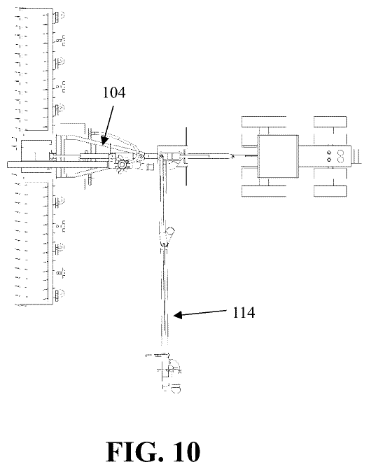

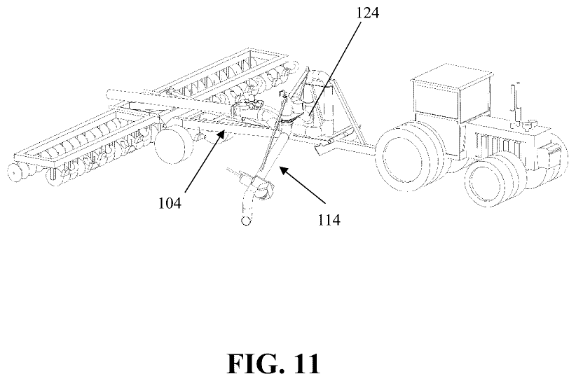

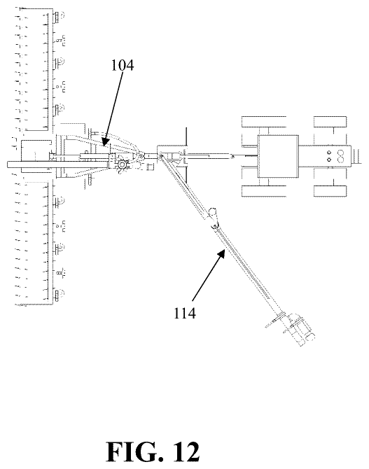

The swing pipe 114 can be mounted to the frame 104 by a base swivel joint 124 and configured for connection with a supply source (e.g., hose) (not shown) to receive manure and/or other liquid nutrients. The swing pipe 114 can include a first, proximal section 126 and a second, distal section 128. As shown, for example, in FIG. 1, a proximal end of the proximal section 126 can be joined to the base swivel joint 124 and a distal end of the distal section 128 can include a supply hose connector 130, which can include a connector swivel joint 132. The distal end of the distal section 128 can further include a cleanout ball catcher 134, which is described in greater detail herein. The base swivel joint 124 can be generally vertically oriented and rotatable about a base swivel joint axis B, which can be generally perpendicular to the longitudinal axis L of the frame 104 and/or a ground. Accordingly, in use, the swing pipe 114 can pivot about the base swivel joint axis B to facilitate receipt of manure and/or other liquid nutrients. Referring to FIGS. 1-12, the swing pipe 114, in an extended position, can be pivoted over a wide range of angles. For example, as shown in FIGS. 1-3, the swing pipe 114 can extend rearwardly from the base swivel joint 124 and be positioned in a straight line, parallel or substantially parallel to the longitudinal axis L of the frame 104. As shown in FIGS. 4 and 5, the swing pipe 114 can be positioned in a straight line, at a 30° angle relative to the longitudinal axis L of the frame 104. As shown in FIGS. 6-8, the swing pipe 114 can be positioned in a straight line, at a 45° angle relative to the longitudinal axis L of the frame 104. As shown in FIGS. 9 and 10, the swing pipe 114 can be positioned in a straight line, at a 90° angle relative to the longitudinal axis L of the frame 104. As shown in FIGS. 11 and 12, the swing pipe 114 can be positioned in a straight line, at a 120° angle relative to the longitudinal axis L of the frame 104. It will be appreciated, however, that a swing pipe can be rotated to any of a range of angles in either direction relative to a longitudinal axis of a frame.

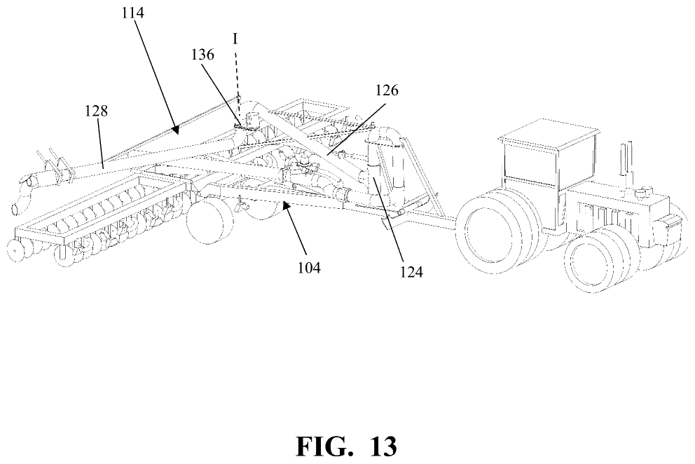

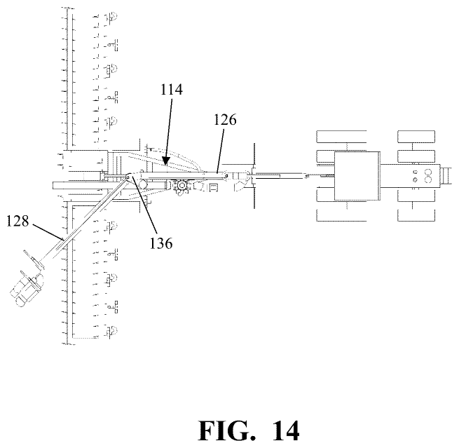

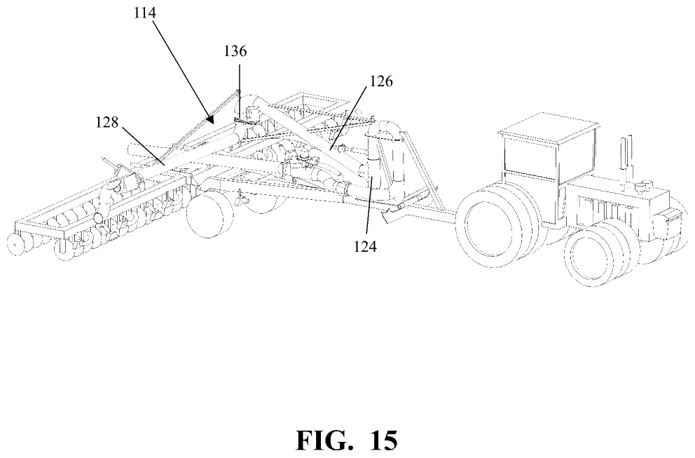

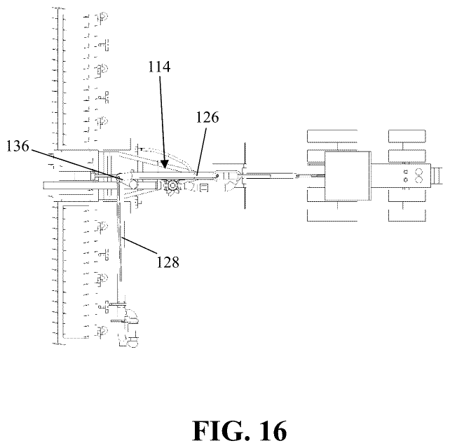

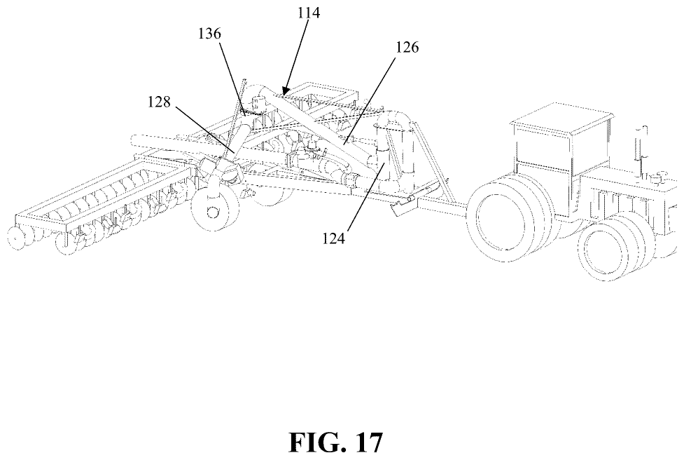

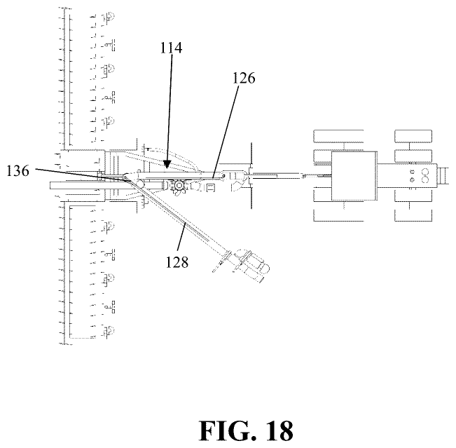

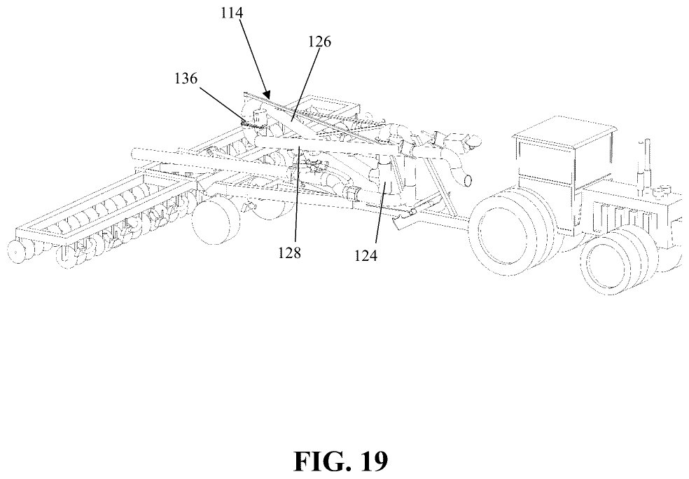

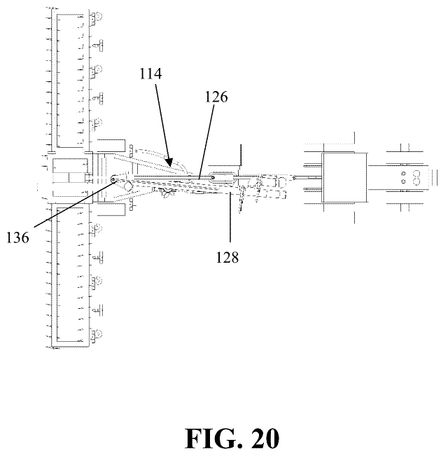

Referring back to FIG. 1, the swing pipe 114 can further include an interior swivel joint 136 to connect the proximal section 126 with the distal section 128. The interior swivel joint 136 can allow the distal section 128 to pivot relative to the proximal section 126. In addition to the rotatability provided by the base swivel joint 124, and, referring to FIGS. 13-20, the interior swivel joint 136 can provide further mobility and adaptability for the swing pipe 114 and the manure distribution system 110. For example, as shown in FIGS. 13 and 14, the proximal section 126 of the swing pipe 114 can be positioned in a straight line, parallel or substantially parallel to the longitudinal axis L of the frame 104, while the distal section 128 of the swing pipe 114 can be positioned at a 45° angle relative to the proximal section 126 and the longitudinal axis L of the frame 104. As shown in FIGS. 15 and 16, the proximal section 126 of the swing pipe 114 is positioned in a straight line, parallel or substantially parallel to the longitudinal axis L, while the distal section 128 of the swing pipe 114 can be positioned at a 90° angle relative to the proximal section 126. Likewise, as shown in FIGS. 17 and 18, the proximal section 126 of the swing pipe 114 is positioned in a straight line, parallel or substantially parallel to the longitudinal axis L, while the distal section 128 of the swing pipe 114 can be positioned at a 120° angle relative to the proximal section 126. And as shown in FIGS. 19 and 20, the proximal section 126 of the swing pipe 114 can be positioned in a straight line, parallel or substantially parallel to the longitudinal axis L, while the distal section 128 of the swing pipe 114 can be positioned at or nearly a 180° angle relative to the proximal section 126, such that the swing pipe 114 can be, essentially, folded back on itself in a compact position. Other configurations of the proximal section 126 and distal section 128 over-and-above the illustrative configurations set forth above are contemplated and included herein.

In certain embodiments, and as shown, for example, in FIG. 13, the interior swivel joint 136 can be rotatable about an interior swivel joint axis I. In certain embodiments, the interior swivel joint axis I can be oriented substantially vertically, but angled slightly rearwardly, such that the distal section 128 ascends slightly, relative to a horizontal plane defined by the frame 104 and/or the ground, as the distal section is rotated toward the proximal section 126. Such configuration can allow for greater rotatability of the distal section 128 relative to the proximal section 126 and a more compact configuration for storage and transport. In some embodiments, the distal section 128 and the proximal section 126 can be of a same or similar length, such that the swing pipe 114, in the compact position, can be reduced to about half of its length. It will be appreciated, however, that an interior swivel joint axis can be oriented in a variety of suitable configurations. As shown, for example, in FIG. 1, rotation of the distal section 128 about the interior swivel joint 136 can be effected or facilitated by a hydraulic motor 138 (i.e., rotational actuator). It will be appreciated, however, that any of a variety of suitable actuators may be used to effect or facilitate rotation of a swing pipe or portion thereof. In certain embodiments, one or more sections of a swing pipe can be extendable and/or telescoping.

As shown, for example, in FIG. 1, the base swivel joint 124 can connect the swing pipe 114 to fluid pipe 140. The fluid pipe can also be in fluid connection with the distributor 116, such that the fluid pipe 140 can allow for a flow of manure and/or other liquid nutrients to the distributor 116. In certain embodiments, and as shown in FIG. 1, the fluid pipe 140 can be a non-rotating pipe, fixed to the frame 104. It will be appreciated, however, that a fluid pipe can be provided in a variety of suitable configurations. In certain embodiments, the distributor 116 can be mounted to the frame.

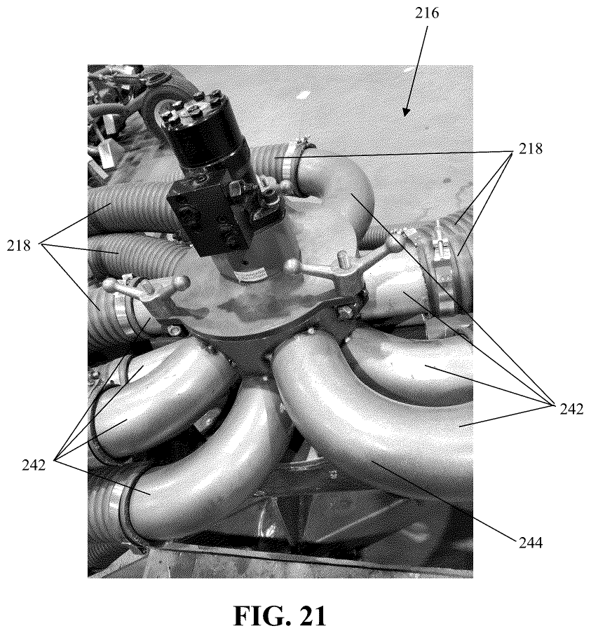

In certain embodiments, and as shown, for example, in FIG. 21, the distributor 216, or manifold, can include an inlet configured for connection with the fluid pipe 140 and a plurality of hose outlets 242 configured for connection with a plurality of distribution hoses 218. In certain embodiments, each of the plurality of hose outlets 242 can be adjoined to and in fluid communication with one of the plurality of distribution hoses 218. The manure incorporation system 100 of FIG. 1 also shows the distributor 116 having hose outlets 142 and the distribution hose 118, but only one distribution hose is depicted in FIG. 1 for the sake of clarity. It is understood that distributor 118 can be the same as or similar to distributor 216. As shown, for example, in FIGS. 1 and 21, each of the plurality of hose outlets 142, 242 can be aligned such that fluid flows through the plurality of hose outlets 142, 242 at respective connections with the plurality of distribution hoses 118, 218 can be in the same or similar axial configuration. For example, each of the respective fluid flows at the respective connections between the plurality of hose outlets 142, 242 and the plurality of distribution hoses 118, 218 can be parallel or substantially parallel to the longitudinal axis L of the frame 104, though respective fluids flows may be in opposing directions (i.e., toward a rear or a front of the frame 104). Accordingly, in certain embodiments, one or more of the plurality of hose outlets 142, 242 can include an elbow 244 to provide for a desired alignment. Conventional distributors include inflexible, radiating-configured hose outlets that require a relatively large amount of space that must be accounted for in storage and transportation thereof. The present distributor 116, 216, however, can allow for a minimal distributor width and a more compact configuration for storage and transport.

The distribution hoses 118, 218 can connect to and be in fluid communication with the plurality of injectors 120, such that the distribution hoses 118, 218 can allow for a flow of manure and/or other liquid nutrients to the plurality of injectors 120. Accordingly, in operation, manure and/or other liquid nutrients can flow from the supply hose, through the swing pipe 114, through the fluid pipe 140, through the distributor 116, through the plurality of distribution hoses 118, 218 to the plurality of injectors 120, and then onto and/or into the ground.

In certain embodiments, the toolbar 108, or portions thereof, can be mounted to the frame 104 with moveable joints, e.g., hydraulic connections, such that the toolbar 108 can be urged downwardly, toward the ground, such that the downward pressure can cause one or more of the plurality of injectors 120 to penetrate the ground. In such embodiments, each of the plurality of injectors 120 can be aligned with a ground-disrupting blade, which can facilitate injection of manure and/or liquid nutrients into a trench. For example, the plurality of discs 112, which can be positioned at a slight angle relative to the ground, can be pressed into the ground a distance to form trench into which fluid can be injected. In certain embodiments, a second plurality of discs can be provided and angled to push dirt back over the trench, thereby covering the trench with deposited manure and/or liquid nutrients.

Upon completion of deposition of manure and/or liquid nutrients, fluid can be cleared from the lines, and such cleaning may be desirable prior to storage and transport of components of the manure incorporation system 100. Application of pressure to lines (e.g., with compressed air) to force an object therethrough, thereby clearing the line, is known in the art. Such conventional methods, however, have drawbacks. For example, the object can be launched great distances and in an unpredictable manner, such that the object can be lost or, potentially, a hazard. In other conventional methods, a large catcher may be provided, but known catchers comprise cages that have limited effectiveness in actually catching the object while spreading fluid to be cleared from the line. Further, such conventional catchers typically require a relatively large amount of space that must be accounted for in storage and transportation thereof.

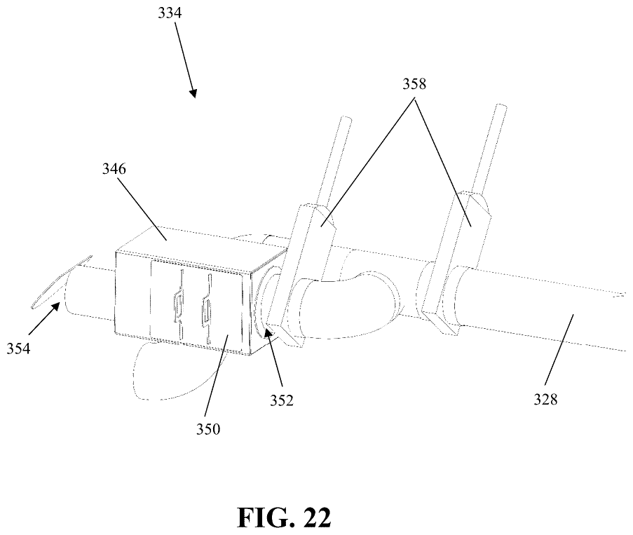

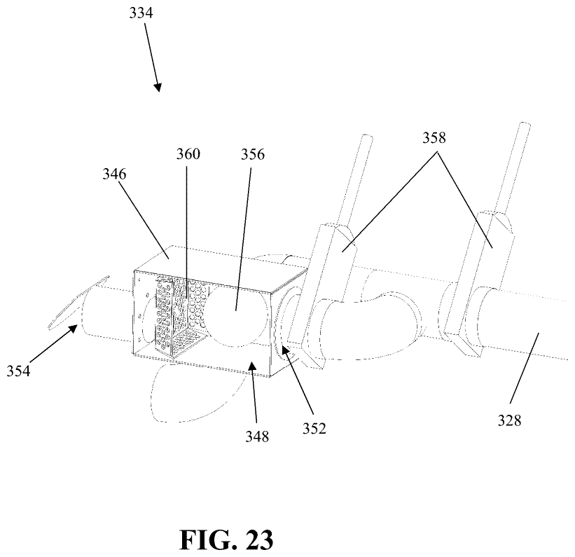

As shown in FIGS. 22 and 23, the distal end of the distal section 328 can further include a cleanout ball catcher 334 including a catcher body 346 defining an interior 348 and having a removable cover 350. The cleanout ball catcher 334 can further include an inlet 352 and an outlet 354. In use, a cleanout ball 356 can be forced through the manure distribution system (e.g., 110) and valves 358 can be adjusted to route the cleanout ball, and thus, fluid to be cleared in a direction of the cleanout ball catcher 334. Upon reaching the cleanout ball catcher 334, the cleanout ball 356 can be caught in the interior 348 of the cleanout ball catcher 334. In certain embodiments, a screen (e.g., tray 360) can be positioned within the interior 348 of the cleanout ball catcher 334 to obstruct the cleanout ball 356 but allow for the fluid to be cleared to exit the cleanout ball catcher 334 through the outlet 354. As shown in FIG. 23, tray 360 can be placed over the outlet 354. The present cleanout ball catcher 134, 334 can effectively retain the cleanout ball 356 while providing sufficient spread upon clearing fluid from the line.

The present cleanout ball catcher 134, 334 can also allow for minimal sizing and a more compact configuration for storage and transport. In certain embodiments, the cleanout ball catcher 134, 334 can be sized to accommodate a size of a line to be cleared and/or air pressure to be applied to the line to be cleared. For example, in certain embodiments, the catcher body 346 can be in the shape of a square, about 12 inches per side; and in other embodiments, sides of the catcher body 346 can be about 16 inches. It will be appreciated, however, that a catcher body can be any of a variety of suitable shapes and configurations over a range of sizes. Similarly, the cleanout ball 356 can be sized to accommodate the line to be cleared, but in certain embodiments, a diameter of the cleanout ball 356 can be about the same size or slightly larger than a diameter of the line to be cleared.

In certain embodiments, the toolbar 108, in a ready-for use position, can be mounted such that a plane defined by the toolbar 108 is generally parallel to the ground and can extend laterally on each side from the longitudinal axis L of the frame 104. In certain embodiments, the incorporation toolbar 108 can include two or more moveable sections, each section being articulatable about one or more toolbar joints. The number and placement of toolbar joints can permit the toolbar sections to be folded, rotated, or otherwise manipulated to minimize the outward extension of the toolbar during transport of the manure incorporation system 100.

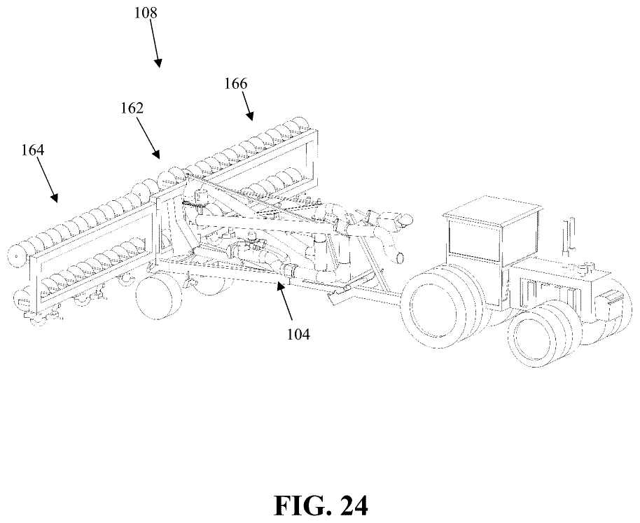

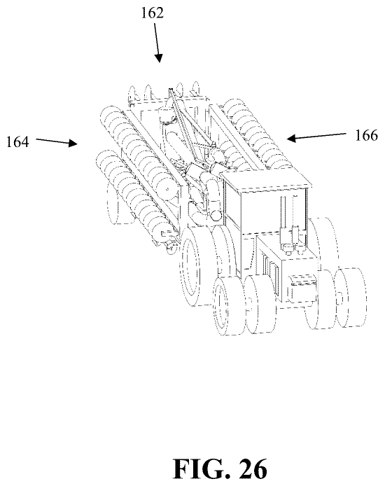

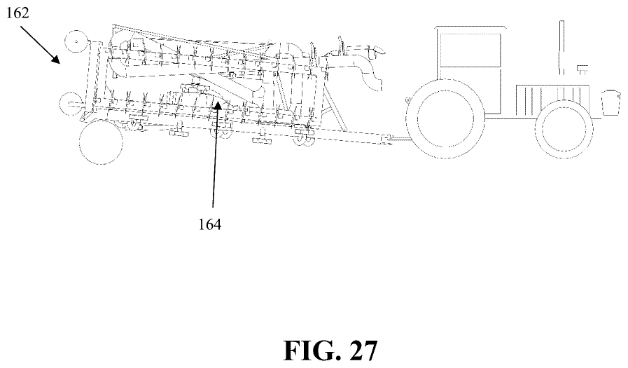

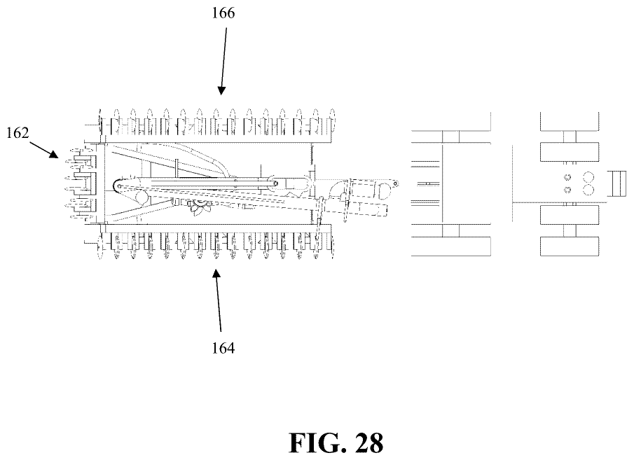

Referring to FIGS. 24-28, for example, the toolbar 108 can include a center portion 162 connected on each side to an outer portion 164 and 166. As shown in FIGS. 24-28, each of the outer portions 164 and 166 can have a width greater than a width of the center portion 162. The center portion 162 can be disposed behind the frame 104 and centered with respect to the longitudinal axis L thereof. Each of the outer portions 164, 166 and center portion 162 can define a plane. In certain embodiments, a total width of the toolbar 108 can span from about 20 feet to about 60 feet, but it will be appreciated that any of a variety of suitable dimensions and configurations can be provided for sections of a toolbar.

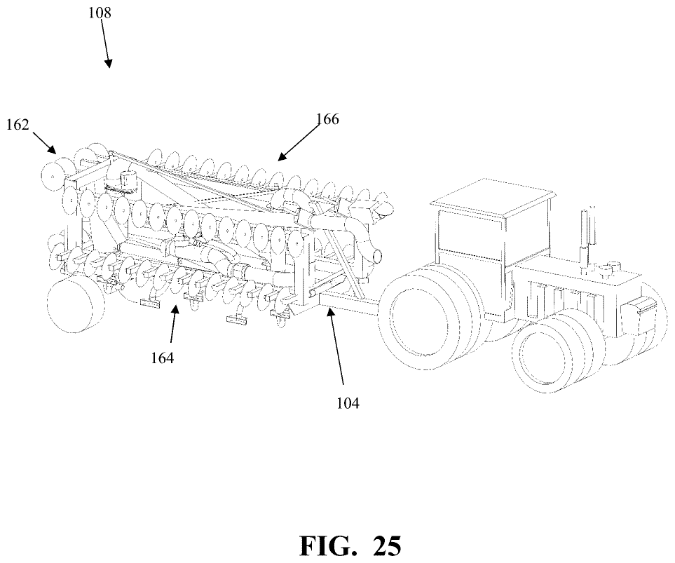

The toolbar 108 can be moveable between the ready-for-use position, as shown in FIGS. 1-20, and a second, compact position, as shown in FIGS. 25-28. To convert the toolbar 108 from the ready-for-use position to the compact position, a rear portion of the toolbar 108 is rotated upwardly until the plane defined by the toolbar 108 is oriented vertically or substantially vertically in an intermediate, raised position, as shown in FIG. 24. In such embodiments, the center portion 162 can be a rearmost portion of the manure incorporation system 100, such that no portion of the manure incorporation system 100 extends rearwardly of the center portion 162. Once the toolbar 108 is in the raised position, outer portions 164 and 166 can rotate forwardly about the toolbar joints connecting the outer portions 164 and 166 to the center portion 162 until the planes defined by the outer portions 164 and 166 are parallel or substantially parallel to the longitudinal axis L of the frame 104 in the compact position, as shown in FIGS. 25-28. As shown in FIG. 25, for example, when the outer portions 164 and 166 are in the compact position, respective planes of the outer portions can be oriented vertically or substantially vertically and can be parallel or substantially parallel to the longitudinal axis of the frame, and when the swing pipe is also in the compact position, the swing pipe can be positioned between the outer portions. It will be further appreciated that a center portion can also be oriented substantially vertically and either perpendicular or substantially perpendicular to the longitudinal axis of the frame when in the compact position.

FIGS. 25-28 illustrate a compact nature of the manure incorporation system 100 when the swing pipe 114 and toolbar 108 are in their respective compact positions. It is believed that the present manure incorporation system 100 can allow for a more compact unit for improved storage and transportation. For example, the manure distribution system 110 can be contained or substantially contained by the toolbar 108, such that components of the manure distribution system 110 are positioned within a width defined by the distance between top portions of the outer portions 164 and 166 in the compact position. As described herein, the sizing and configurations for each of the swing pipe 114, distributor 116, and cleanout ball catcher 134 can allow for relatively minimal widths and a more compact manure incorporation system configuration for storage and transport. For example, in certain embodiments, a width of the manure incorporation system 100 in the compact position can be about 14 feet or less; and in other embodiments, the width of the manure incorporation system 100 in the compact position can be about 12 feet or less. The present manure incorporation systems 100 can reduce or eliminate the need to disassemble the same or portions thereof prior to storage and/or transport. Such configurations can also allow for the use of larger manure incorporation systems for the distribution of manure and/or other liquid nutrients. It will be appreciated that while the embodiment shown in FIGS. 1-20 and 24-28 depicts specific types of components (e.g., a high-speed disc), other suitable types of toolbars, frames, and manure distribution systems can be used in a manure incorporation system.

In certain embodiments, a method of using a compact manure incorporation system can include providing a compact manure incorporation system as described herein, receiving manure through a distal end of the distal section of the swing pipe, and distributing manure from the swing pipe through a plurality of injectors mounted on the toolbar. In such embodiments, the method can also include cleaning the swing pipe by forcing a cleanout ball therethrough. In such embodiments, the method can include moving the proximal section and the distal section of the swing pipe into a compact swing pipe position; and moving a first outer portion and a second outer portion of the toolbar to a compact toolbar position, such that when the first and second outer portions are in the compact toolbar position, and when the swing pipe is in the compact swing pipe position, the swing pipe is positioned between the first and second outer portions of the toolbar.

It will be appreciated that a manure incorporation system can include a high-speed disc (i.e., parallel disc) available from Landoll; an injector can be Bazooka-style injector, available from Bazooka Farmstar; a distributor can be a DosiMat DMX distributor available from Vogelsang US, Ravenna, Ohio; and a distribution hose can be a rubber (e.g., EPDM) hose with a polyethylene helix, available from The Hose Guru, Fort Wayne, Indiana. It will be further appreciated that other components can be obtained from commercial outlets, as desired, and that all connections between components can be of a variety of suitable connections as known in the art.

In various embodiments disclosed herein, a single component can be replaced by multiple components and multiple components can be replaced by a single component to perform a given function or functions. Except where such substitution would not be operative, such substitution is within the intended scope of the embodiments.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

What is claimed is:

1. A compact manure incorporation system comprising:
a frame defining a longitudinal axis;
a manure distribution system comprising a swing pipe, the swing pipe comprising a first, proximal section and a second, distal section;
wherein a proximal end of the proximal section is mounted to the frame and a distal end of the proximal section is pivotably connected to a proximal end of the distal section; and
wherein the proximal section and distal section are configured to pivot relative to each other between an extended swing pipe position and a compact swing pipe position.

2. The compact manure incorporation system of claim 1, wherein the proximal section and distal section are connected by an interior swivel joint.

3. The compact manure incorporation system of claim 2, wherein the interior swivel joint is rotatable about an interior swivel joint axis, wherein the interior swivel joint axis is oriented substantially vertically.

4. The compact manure incorporation system of claim 1, wherein the proximal section is pivotable relative to the frame.

5. The compact manure incorporation system of claim 1, further comprising a toolbar mounted to the frame.

6. The compact manure incorporation system of claim 5, wherein the toolbar comprises a first outer portion and a second outer portion, wherein each of the first and second outer portions defines a plane and is configured to move between a ready-for-use toolbar position and a compact toolbar position; and
wherein, in the compact toolbar position, respective planes of the first and second outer portions are parallel or substantially parallel to the longitudinal axis of the frame.

7. The compact manure incorporation system of claim 6, wherein, when in the compact toolbar position, the respective planes of the first and second outer portions are oriented vertically or substantially vertically.

8. The compact manure incorporation system of claim 7, wherein, when the first and second outer portions are in the compact toolbar position, and when the swing pipe is in the compact swing pipe position, the swing pipe is positioned between the first and second outer portions.

9. The compact manure incorporation system of claim 8, wherein toolbar further comprises a center portion defining a plane and configured to move between the ready-for-use toolbar position and the compact toolbar position.

10. The compact manure incorporation system of claim 9, wherein, when in the compact toolbar position, the plane of the center portion is oriented substantially vertically and either perpendicular or substantially perpendicular to the longitudinal axis of the frame, such that the first, second, and center portions of the toolbar surround the swing pipe in the compact swing pipe position.

11. The compact manure incorporation system of claim 1, wherein the toolbar further comprises a ground engaging system including a plurality of discs, sweeps, coulters, or points.

12. The compact manure incorporation system of claim 1, wherein the manure distribution system further comprises:
a distributor in fluid connection with the swing pipe and having a plurality of hose outlets;
a plurality of distribution hoses, wherein each of the plurality of distribution hoses is joined to and in fluid communication with one of the plurality of hose outlets, and
a plurality of injectors in fluid connection with the plurality of distribution hoses.

13. The compact manure incorporation system of claim 12, wherein the plurality of hose outlets, at respective connections with the plurality of distribution hoses, are in a similar axial configuration.

14. The compact manure incorporation system of claim 13, wherein the plurality of hose outlets, at respective connections with the plurality of distribution hoses, are parallel or substantially parallel to the longitudinal axis of the frame.

15. The compact manure incorporation system of claim 1, wherein a distal end of the distal section is configured for connection with a manure supply source; and
wherein the distal end of the distal section comprises a cleanout ball catcher.

16. The compact manure incorporation system of claim 15, wherein the cleanout ball catcher comprises:
a catcher body defining an interior, an inlet, and an outlet and having a removable cover; and
a screen configured for positioning within the interior to obstruct a cleanout ball entering through the inlet from exiting through the outlet.

17. A method of using the compact manure incorporation system, the method comprising:
providing the compact manure incorporation system of claim 1;
receiving manure through a distal end of the distal section of the swing pipe;
distributing manure from the swing pipe through a plurality of injectors mounted on the toolbar;
moving the proximal section and the distal section of the swing pipe into a compact swing pipe position; and
moving a first outer portion and a second outer portion of a toolbar mounted to the frame to a compact toolbar position, such that when the first and second outer portions are in the compact toolbar position, and when the swing pipe is in the compact swing pipe position, the swing pipe is positioned between the first and second outer portions of the toolbar.

18. The method of claim 17, further comprising:
cleaning the swing pipe by forcing a cleanout ball therethrough.

19. A distributor for a compact manure incorporation system, the distributor comprising:
an inlet configured for connection with a supply source; and
a plurality of hose outlets, wherein each of the plurality of hose outlets is configured for connection with a plurality of distribution hoses;
wherein the plurality of hose outlets, at respective connections with the plurality of distribution hoses, are in a similar axial configuration, such that the plurality of hose outlets are parallel or substantially parallel to each other.

20. A cleanout ball catcher for a compact manure incorporation system, the ball catcher comprising:
a catcher body defining an interior, an inlet, and an outlet and having a removable cover; and
a screen residing within the interior to obstruct a cleanout ball entering through the inlet from exiting through the outlet.
